(19) United States
(12) Patent Application Publication
(10) Pub. No.: US 2005/0029757 A1
(43) Pub. Date: Feb. 10, 2005

(54) Swivelable mount for attaching a binding to a snowboard

(76) Inventor: Jon Fiebing, Carlsbad, CA (US)

Correspondence Address: Jon Fiebing, 5474 Park Road South, Traverse City, MI, 49684, US

(21) Appl. No.: 10/937,173

(22) Filed: Sep. 9, 2004

Related U.S. Application Data
(63) Continuation-in-part of application No. 10/066,382, filed on Feb. 1, 2002, now abandoned.

(51) Int. Cl. B62B 17/00

(52) U.S. Cl. 280/14.24

(57) ABSTRACT

Mount 10 for attaching a boot binding 110 to a snowboard 100 allows free swiveling of binding 110 in a plane non-parallel to the deck of snowboard 100. Mount 10 includes a swivel assembly 20 with an upper face 8 for attaching a boot binding 120, a lower face 5 for attaching a snowboard, and cant disk 60 for canting boot binding 110 to an angle non-parallel to the deck of snowboard 100.

### CROSS-REFERENCE TO RELATED APPLICATION

This application is a continuation-in-part of co-pending application Ser. No. 10/066,382; filed Feb. 1, 2002.

### FIELD OF THE INVENTION

This invention relates to a mount for attaching boot bindings to a snowboard, and more particularly to a mount that allows the binding to swivel freely while lifting the binding at a comfortable cant angle.

### BACKGROUND OF THE INVENTION

Snowboards are a type of sportboard used for sliding downhill on snow, propelled by gravity. Since about 1980, snowboards have evolved as hybrids of skis and skateboards. Skiers now share the hills and mountains equally with snowboarders.

The typical snowboard in use in 2002 is similar to an enlarged skateboard with turned up ends, a smooth undersurface, and a symmetrical, slightly curved shape as that of an hourglass. There are no trucks or wheels, so the snowboard is steered by the rider by shifting his or her weight, causing the snowboard to flex slightly downward in the middle and dig one of its inwardly curved edges evenly along its length into the snow, more than the other edge. To make a sharper turn, weight is shifted front to back, deweighting one end and allowing the other end to be pivoted.

The snowboard is typically fixed to the rider's feet by bindings that clamp or enclose the rider's boots, similar to the boot and binding combination used for skiing. Bindings are necessary because snowboarders, like skiers, wear heavy boots that keep the feet warm and allow walking in deep snow.

Skateboarders do not need bindings because they typically wear soft, light shoes with rubber soles that stick to the skateboard. Also, a skateboard pivots easily on its trucks and does not need much force to steer it.

Because a snowboard has to support the rider's weight over snow, including soft deep powder, the snowboard has at least two or three times the area of a normal skateboard. This larger board requires more force and more exaggerated weight shifts in order to steer it than are needed for a skateboard. Because standard snowboard bindings attach the rider's boots in a fixed position, these exaggerated weight shifts for steering can require much preparation and often feel and appear abrupt when executed. Because the current method of steering a snowboard creates abrupt weight-shifts, the rider must compensate by holding his arms straight out for balance, which is not aerodynamic and can appear clumsy. Therefore, it is desirable that snowboarders be provided with equipment improvements that eliminate steering preparation and the feeling and appearance of abruptness.

Standard snowboard bindings attach the rider's boots in a fixed position generally transverse the snowboard, frequently with the toes slightly toward the nose of the board. There are adjustable bindings in use that let the snowboarder rotate the binding in a plane parallel to the plane of the snowboard. Adjustable bindings let the user adapt the attachment angle of the bindings, and hence the feet, relative to the board to suit the user's preference and skill level. These bindings have various locking means that are unlocked by the rider's hands to allow rotation of the binding, then are re-locked by hand to prevent rotation during riding.

Snowboarders typically denote the longitudinal edges of their snowboards as “frontside” (sometimes “toeside”) edge, which is the longitudinal edge nearest the bound toes, or “backside” (sometimes “heelside”) which is the longitudinal edge nearest the bound heel. Snowboard edges are generally sharp and follow the hourglass contour of the shape of the board.

Snowboarders face a particular problem when encountering natural flat spots while riding on the hill or mountain, in comparison to skiers. As they lose gravitational momentum in the “flats,” snowboarders are forced to use the “skateboarding” technique to regain speed, which involves slowing themselves down even more so that they can use their hands to release one foot from a binding, usually the back foot, then use that leg to push against the slippery ground, in the fashion of a skateboarder.

The skateboarding technique has several disadvantages for snowboarders. It is not spontaneous, because riders are forced to slow down or stop, in order use their hands to release one bound foot. It is awkward and uncomfortable, because it leaves the one bound foot at generally a perpendicular angle to the pushing foot and the direction of the snowboard, thus stressing that leg's knee. It is not mechanically advantageous, as it only uses the power of one leg pushing on slippery snow, leaving the other leg, both arms and the torso muscles un-engaged in task of creating speed. Finally, once some momentum is achieved with the skateboarding technique, the snowboarder must break momentum once more to use his hands to re-bind the leg before they proceed down a steeper part of the hill.

In comparison, skiers react spontaneously to gravitational momentum loss by employing the more effective techniques of “skating” and “poling.” Skiers “skate” with their leg muscles by lifting one ski off the snow, rotating the direction and angling the plane of that ski for leverage, then pushing off the snow with inner, lower edge of that angled and rotated ski, in the fashion of an ice skater. Skiers will fluidly change the degree of rotation and angle of their skis when “skating” based on the amount of speed they want to create and the pitch of the hill. Skiers “pole” with their arm muscles by pushing the ground with their ski poles. Most skier's use “skating” and “poling” in conjunction for greatest muscular mechanical advantage, resulting in a much faster and more spontaneous technique for traversing the flats than that of snowboarders. Therefore, it is desirable that snowboarders be provided with equipment improvements that allow them to spontaneously take mechanical advantage of fluidly rotational, angled leg leverage for both legs, like skiers do, in order to generate speed in the flats.

Another patent of mine, “USER PROPELLABLE SPORT BOARD DEVICE, Fiebing U.S. Pat. No. 6,579,134 B1, describes a binding rotation system for snowboards and surfboards that allows the rider to spontaneously and continuously rotate both feet, which are connected to fins below the board. This allows the riders to generate nonholonomic locomotion, via the gait pattern that propels today's streetboards. A streetboard is a modified skateboard with two rotatable foot platforms connected to the trucks. Streetboarders generate nonholonomic locomotion from a stand-still by repeatedly twisting their torso inward while rotating their toes together then twisting their torso outward while rotating their toes outward, and slightly leaning their body in the direction of rotation. The “streetboard gait” pattern is an improved method of skateboard propulsion that allows the rider to engage both leg and torso muscles in the act of generating speed, without ever lifting either foot off of the skateboard. The “streetboard gait” pattern served as the inspiration for the California Institute of Technology 1993 study “Nonholonomic mechanics and locomotion: the Snakeboard example” by Lewis, et al., who conclude that “the snakeboard model: (1) is an interesting problem in nonholonomic mechanics; (2) represents an unexplored class of systems which may be used for locomotion; and (3) serves as a motivating example for developing new frameworks for exploring the relationship between nonholonomic mechanics and locomotion.” The referenced “Snakeboard,” U.S. Pat. No. 4,955,626, was the first commercially available streetboard. Streetboards today are commercially available today from a variety of companies including Dimension, Anderson, Snakeboard, and formerly my company, AlterSkate.

Because my “USER PROPELLABLE SPORT BOARD DEVICE, Fiebing U.S. Pat. No. 6,579,134 B1 is fluidly rotational, it provides snowboarders the means to generate nonholonomic locomotion via the “streetboard gait” pattern and therefore take mechanical advantage of both leg and torso muscles. However, it has the disadvantage of being not easily retro-fittable to a conventional snowboard because fins must be disposed below the snowboard, and, although fluidly rotational, it does not provide a means to create angled leg leverage, which is integral to the “skating” technique of skiers.

Other attempts to address the problem of snowboarders traversing the flats have focused on making the skateboarding technique more comfortable by creating hand adjustable and releasable devices which allow the rider to rotate his or her bound front foot to a more natural, straight ahead position. Hand releasable, binding rotation mechanisms are taught by Vetter, Dawes and LaVoy, U.S. Pat. Nos. 5,354,088, 5,586,779 and 6,450,511 B1, respectively. These inventions do not facilitate spontaneity because they force the rider to bend down in order to hand release the binding rotation lock mechanism of one foot, reposition that foot binding into a more forward position, re-engage that rotation lock device, then use hands again to fully uncouple the other foot from its binding in order to employ the skateboard technique Also, these inventions do not provide a means for the rider to spontaneously take mechanical advantage of fluidly rotational, angled leg leverage as skiers do. Finally, because these inventions will not fluidly rotate continuously, they do not provide the means to allow the snowboarder to generate nonholonomic locomotion via the streetboard gait.

Dodge (U.S. Pat. No. 5,915,718) is another example of a hand adjustable and releasable device which allows the rider to rotate then relock his binding into a different position. Dodge further teaches that inserting a cant/lift between the binding and the board to tilt the rider's feet toward each other puts “the rider's knees into an ‘A’ configuration which some riders find to be a particularly powerful stance.” The Dodge patent discloses a cant/lift that maintains the desired “A” configuration when the binding is rotated on the board. Thus prior art allows for differing preferences for foot position and cant among riders, but requires the rider to lock into one fixed position before a run, if not before even arriving at the snowboarding slope, thereby eliminating the possibility fluid foot rotation, which eliminates the ability to create nonholonomic locomotion via the streetboard gait and eliminates the ability to create rotational leg leverage like skiers do.

Sabol (U.S. Pat. No. 6,062,584) provides a hand releasable device which allows the rider to fluidly rotate then relock his binding into a different position. Although Sabol provides for 100 degrees of fluid rotation, he teaches away from fluid rotation during downhill riding and teaches the desirability of the skateboarding method of snowboard propulsion (column 5, line 15: “A primary object of the present invention is to provide a . . . rotatable snowboard boot binding which has a slip sleeve binding tab screw-type locking mechanism . . . [that] insures that the boot will not slip out of the desired position for downhill boarding with both feet angled, or for level and uphill propelling with one foot aligned with the snowboard and the other free.). Sabol also does not provide for angled leg leverage that skiers find beneficial.

Duggan (U.S. Pat. No. 6,257,614) teaches that pivoting the ankles and feet while the snowboard is in motion is useful and allows the rider to perform maneuvers that are impractical with locked down bindings. Duggan discloses pivotable bindings for sportboards that are tied in synchrony by a belt or other drive means. Duggan teaches, “Essentially both feet must pivot at the same time and in the same direction . . . . Drive belt 70 maintains rotational timing between the rider's feet to prevent a foot ‘stance misalignment’ which might cause injury to the rider and/or loss of control of the sportingboard.” Prior art thus teaches that the ability to vary the rotational direction of the feet on a snowboard is useful, but must be strictly limited in order to maintain control of the board. Duggan U.S. Pat. No. 6,257,614 also has the disadvantages of not being easily retro-fittable to a conventional snowboard, not providing for rotational angled leg leverage that skiers find useful, and eliminates the ability for the rider to generate nonholonomic locomotion via the streetboard gait because of the connected drive belt.

My insight into nonholonomic locomotion of modified skateboards, surfboards and snowboards via the streetboard gait, the design shortcomings of my invention Fiebing U.S. Pat. No. 6,579,134 B1 for use with standard snowboards, and the lack of any other prior art that solved the problem of snowboarders generating speed in the flats in a spontaneous manner consistent with the sport, were all factors behind the invention of the present mount.

### SUMMARY OF THE INVENTION

The present invention is a mount for connecting a binding to a snowboard in a manner that allows for free and dynamic motion of the legs, ankles, and feet, at all times. The primary aim of the present invention is to provide a binding mount retro-fittable to a conventional snowboard, without hand release or lock mechanisms, that allows the snowboarder to generate locomotion in a more spontaneous, mechanically advantageous way than present, by combining the nonholonomic locomotion principles behind the “steetboard gait” with the benefits of rotational, angled leg leverage used by skiers. The secondary aim of the mount of the present invention is to provide an improved steering mechanism for a snowboard. Other aims of the mount of the present invention are to allow a skilled snowboarder to execute tighter turns than with prior art bindings, to reverse direction more easily, and to spin 360 degrees parallel to the snow surface from a standstill.

The mount of the present invention is used by attaching the lower face of the mount to a snowboard and attaching the upper face to a standard binding. Usually, a pair of mounts is used to attach a pair of bindings to the board. Each mount includes a swivel assembly that swivels freely and independently of the other mount of the pair. The rider can vary his or her stance continuously, as desired.

The mount includes a cant disk for canting the feet relative to the surface of the snowboard. The cant disk is a disk generally the same diameter as the swivel assembly, with a thickness that increases linearly across the diameter of the disk. It is typically oriented such that the thinnest part of the disk is below the arch of the rider's foot and the thickest part of the disk is near the outer edge of the foot. The total thickness of the mount is such that the foot may be swiveled freely in a circle without the toe or other part of the boot contacting the snowboard.

The cant disk may be disposed under the swivel assembly, resulting in canting of the axis of rotation of the swivel assembly away from vertical (first embodiment), or the cant disk may be disposed above the swivel assembly, in which case the axis of rotation is vertical and perpendicular to the longitudinal axis of the snowboard (second embodiment). The two configurations have different behaviors as related to nonholonomic locomotion via the streetboard gait and snowboard steering during general riding.

The canted axis of rotation of the first embodiment angles the rider's legs inward and directly over the longitudinal axis of the snowboard at all times, resulting in a focused center of power and gravity at the rider's torso. As the snowboarder practices the “streetboard gait” by repeatedly twisting his torso inward while rotating his toes together and leaning “frontside,” then twisting his torso outward while rotating the toes outward and leaning “backside,” the inwardly canted rotating mount axis creates slight instances of gyroscopic precession, which has the effect of stabilizing the rider's twisting, rotating, leaning body, and centering its power at the torso for maximum torsion. The rider's leaning force also increases normal downward flexure of at the middle of the snowboard, and also tilts the snowboard on edge. The force from the rider's torsion thrust creates forward momentum, which combines with the leaning forces being applied to the inwardly curved, downwardly flexing, tilted edges of the snowboard. This combination of forces creates a small burst of speed each time the rider changes the twisting, rotating and leaning direction of his body and feet while practicing the “streetboard gait,” which the rider feels as the snowboard edge digs in. Expert practitioners of the “streetboard gait” using the mount of the present invention on a snowboard average about one speed burst per second, which has been found to assure a minimum retention of speed in the “flats.”

Because a snowboard is steered by the rider shifting his weight from one edge to the other, the first embodiment of the mount of the present invention also provides improved 4from one edge to the other, by allowing to rider to spontaneously begin the process of weight-shift by rotating his feet in the direction of desired shift. Compared with traditional, locked-in-place bindings, weight-shift becomes a process that requires little planning, is achieved smoothly instead of in a lurching fashion and therefore does not require the rider to hold his arms out in a non-aerodynamic fashion to keep his balance after the lurch. As a steering mechanism, the first embodiment of the mount of the present invention compares to the “gooseneck” mechanism of a bicycle in that each have inwardly canted rotation axis for optimum balance.

The perpendicular axis of rotation of the second embodiment of the present mount in combination with its canted, rotating disk creates different behaviors as related to nonholonomic locomotion and steerability than that of the first embodiment. As the rider of the second embodiment practices the streetboard gait, the canted faces of the disks slope toward the “backside” edge of the snowboard when the rider rotates his toes together, then to the “frontside” edge of the board when the toes are rotated away from each other. This has the effect of repeatedly shifting rider's center of balance and power from one board edge to the other, in comparison with the first embodiment, where the center of balance and power remains directly above the longitudinal axis of the snowboard. When this constantly shifting center of balance is mastered, riders find it advantageous because it allows them to apply even more leaning force on the edges of the board while practicing the streetboard gait, providing for a slightly greater burst of forward speed than can be provided by the first embodiment. The second embodiment of the present mount allows a snowboarder to most closely emulate a skier's “skating” technique of propulsion in that it provides a mechanism to spontaneously and repeatedly apply angled leg leverage to each inside edge of the rotated, angled board.

Because a snowboard is steered by the rider shifting his weight from one edge to the other and digging that edge into the snow, the second embodiment of the present mount also provides improved steerability. When the canted faces of the disks are rotated to slope toward an edge of the snowboard, greater leverage is exerted on that edge, thus improving steering responsiveness.

### BRIEF DESCRIPTION OF THE DRAWINGS

FIG. 1 is a perspective view of a first embodiment of the mount of the present invention attached to a snowboard, which is partially cut away.

FIG. 2 is a perspective view of a second embodiment of the mount of the present invention attached to a snowboard, which is partially cut away.

FIG. 3 is a back view of the mount of FIG. 1 with a typical boot binding attached.

FIG. 4 is a back view of the mount of FIG. 2 with a typical binding attached.

FIG. 5 is a top view of a snowboard with a pair of mounts attached in an exemplary orientation, showing the outline of the rider's boots.

FIG. 6 is a top view of a snowboard with a pair of mounts attached in an alternative orientation, showing the outline of the rider's boots.

FIG. 7 is an exploded view of the mount of FIG. 1.

FIG. 8 is an exploded view of the mount of FIG. 2.

FIG. 9 is an exploded back view of an alternative embodiment of the mount of FIG. 1 and includes a detached typical snowboard binding.

FIG. 10 is an exploded back view of an alternative embodiment of the mount of FIG. 2 and includes a detached typical snowboard binding.

### DETAILED DESCRIPTION OF THE DRAWINGS

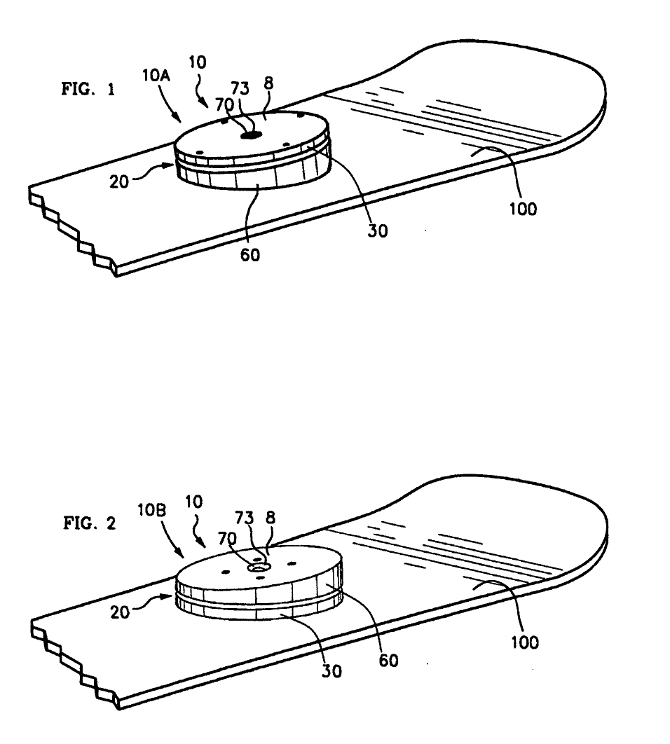

FIGS. 1 and 2 are perspective views of co-typical first and second embodiments 10A and 10B of mount 10 of the present invention attached to a snowboard 100, shown partially cut away. The upper face 8 of mounts 10A and 10B serves as a mounting plane for attachment of a binding. Typically, a pair of mounts 10 are mounted on snowboard 100, each with one binding attached. Mount 10 includes swivel assembly 20 and cant means, such as cant disk 60.

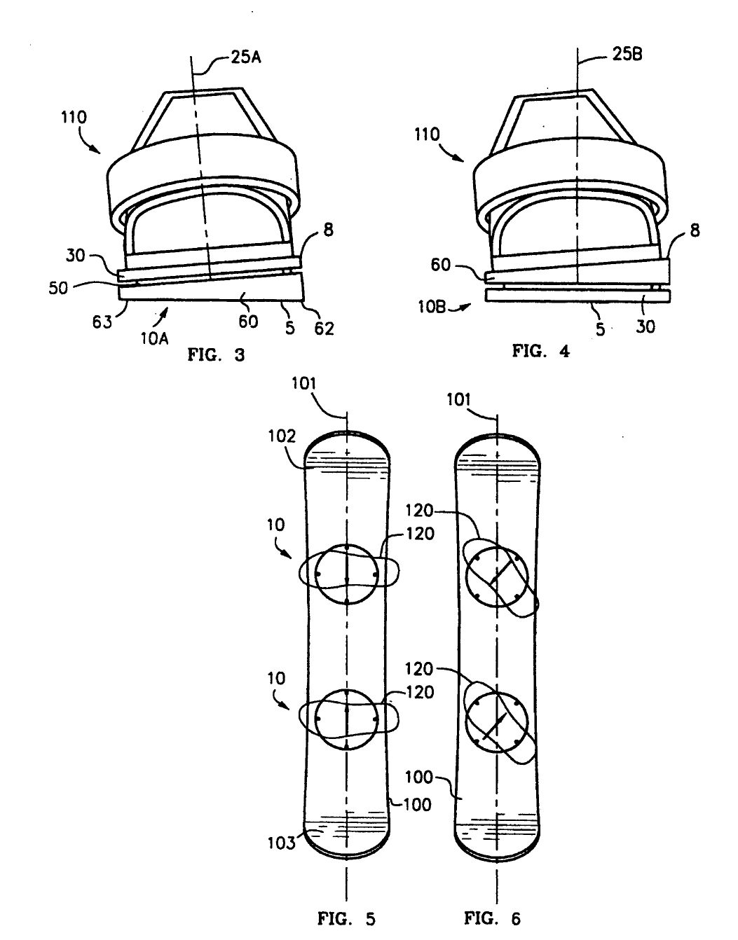

FIG. 3 is a back view of first embodiment of mount 10, mount 10A, with an exemplary binding 110 attached to upper surface 8. Mount 10A includes swivel assembly 20 comprised of cant disk 60 and plate 30, such that swivel assembly 20 has a swivel axis 25A that is not normal to the plane of snowboard 100 and generally parallel to the rider's leg when standing erect.

FIG. 4 is a back view of second embodiment of mount 10, mount 10B, which includes cant disk 60 disposed above first plate 30, such that swivel assembly 20 has a swivel axis 25B that is normal to the plane of snowboard 100, and not normal to the mounting plane. Swivel axis 25B is not generally parallel to the rider's leg when standing erect.

First embodiment 10A and second embodiment 10B each provide the rider with a different riding behavior of snowboard 100, which may be understood with reference to FIG. 5.

FIG. 5 is a top view of a pair of mounts 10 attached to snowboard 100. The outlines of the rider's boots 120 are superimposed. The arrows indicate the orientation of the cant, pointing toward thinnest (lowest) part 63. Boots 120 are generally transverse snowboard 100 (perpendicular to longitudinal axis 101) and canted toward each other. This may be called a “neutral stance,” which the rider would use to move forward down a moderate slope. The rider's weight is centered over longitudinal axis 101, midway between the two mounts 10.

Canting boots 120 toward each other decreases stress on the rider's ankles and centers the rider's weight. Typically, a person's legs are parallel and vertical when standing with the feet together. A person standing with the feet about 18 inches apart, as is typical when riding a snowboard 100, has legs that are not vertical, but are angled toward each other. If boots 120 were attached to snowboard 100 with the soles parallel to the deck of snowboard 100, the ankles would be bent uncomfortably to connect the flat feet to the angled legs. A main purpose of cant disk 60 is to compensate for the angle of the legs, allowing the ankles to be straight in the neutral stance.

If mounts 10 of FIG. 5 are mounts 10A, then when the rider swivels mounts 10A, such as by pointing the toes of both boots 120 toward the nose 102 of snowboard 100, the cant orientation relative to snowboard 100 remains as shown by the arrows. In this toes-forward stance, the toes of front boot 120 are canted “uphill” from the heel, the toes of back boot 120 are canted “downhill” from the heel, and the rider's weight remains centered over longitudinal axis 101. Even when the rider changes stance by 180°, boots 120 remain canted toward each other and the legs are in the comfortable “A” posture.

If mounts 10 of FIG. 5 are mounts 10B, the neutral stance is identical to that described above for mount 10A. However, when the rider swivels mounts 10B to a toes-forward stance, each boot 120 remains canted as it was in the neutral stance. Because swivel axis 25B is not generally parallel to the rider's leg, the rider's center of gravity will shift to either side of longitudinal axis 101 based on the degree to which each boot is rotated.

Mount 10B might be preferred by a highly skilled rider who frequently reverses the direction of travel by swiveling to face either nose 102 or tail 103 of board 100. Mount 10B might also be preferred by riders who wish to apply angled leg leverage to the edges of their snowboards. However, a less skilled rider might be inconvenienced by the shifting of his or her center of gravity across longitudinal axis 101.

FIG. 6 is a top view of a pair of mounts 10A attached to snowboard 100 in an alternative orientation. The outlines of the rider's boots 120 are superimposed. The arrows indicate the orientation of the cant, pointing toward thinnest part 63. The toes of boots 120 are pointing somewhat toward nose 102 in the neutral stance. Boots 120 are not canted toward each other, but are each canted toward longitudinal axis 101. The rider's center of gravity is over longitudinal axis 101. With mounts 10 mounted to snowboard 100 as shown in FIG. 6, the rider finds it easier to shift the center of gravity toward nose 102 than with the orientation of FIG. 5. This stance is appropriate for a rider who wishes to maximize downhill speed by tucking into an aerodynamic crouch with the center of gravity closer to nose 102, but centered over longitudinal axis 101.

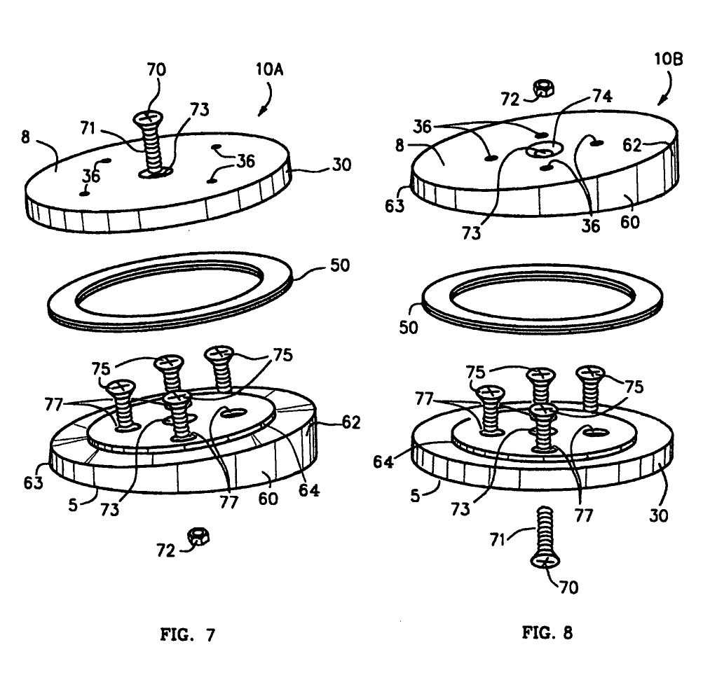

FIG. 7 is an exploded view of first embodiment mount 10A of FIG. 1, and FIG. 8 is and exploded view of second embodiment mount 10B of FIG. 2. For mount 10, swivel assembly 20 can be disassembled and includes plate 30, cant disk 60, and bearing 50 between plate 30 and cant disk 60. Bearing 50 allows plate 30 and cant disk 60 to swivel completely freely relative to each other. Bearing 50 is secured by inner retaining surface 64. A swivel connector 70, such as bolt 71 and nut 72, connects plate 30, bearing 50, and cant disk 60 in a stack. Bolt 71 passes through middle-hole 73 at the centers of plate 30 and cant disk 60 and is retained by nut 72, which rests on nut shoulder 74 (hidden in FIG. 7). Cant disk 60 is a disk of generally the same diameter as plate 30. The thickness of cant disk 60 decreases linearly across the diameter of cant disk 60, from thickest part 62 to thinnest part 63. Generally, swivel assembly 20 of mount 10 could be considered as comprising a lower portion, comprising the lower race and all parts below; and an upper portion, comprising the upper race and all parts above, freely swivelable relative to the lower portion about a swivel, or bearing, axis.

Mount 10 is attached to snowboard 100 with lower face 5 against the top deck of snowboard 100. Snowboards 100 typically have predrilled holes for mounting a conventional binding. Mount 10 is attached to snowboard 100 with screws 75 that pass through the appropriate holes 77 in lower face 5 and into the existing holes in snowboard 100. Mount 10 preferably includes predrilled holes of both standard square and triangle hole patterns in upper face 8 and lower face 5.

Similarly, upper face 8 is attached to a standard binding by screws (not shown) that pass through holes in the binding and into mating holes 36 in upper face 8. Upper face 8 preferably includes predrilled holes in both the square and the triangle pattern typically found on bindings. 60.

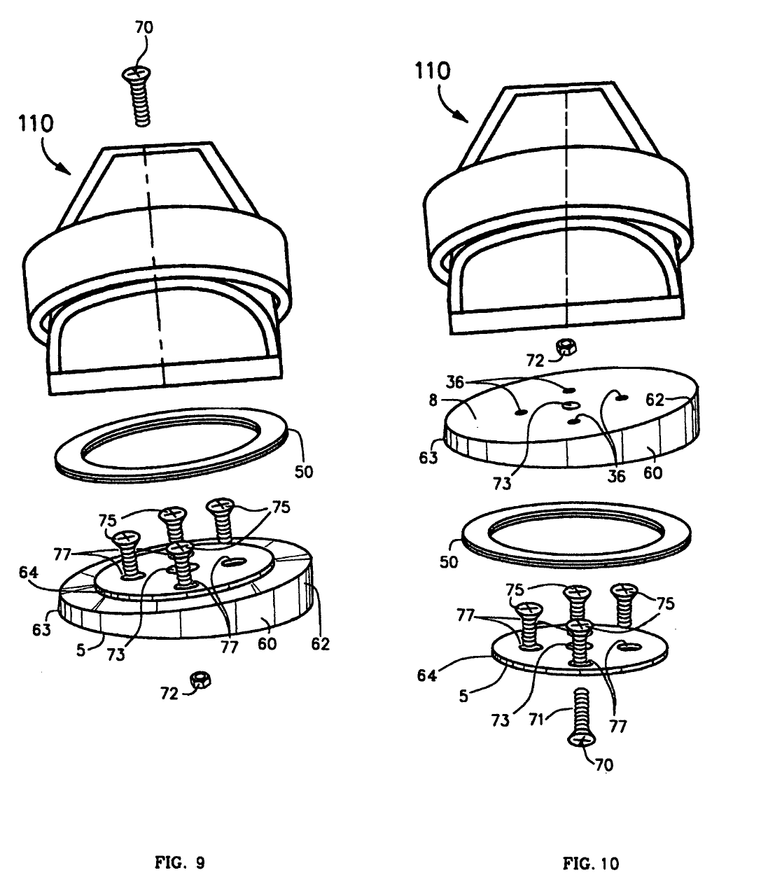

FIG. 9 is an exploded view of an alternative embodiment of mount 10A including exemplary binding 110. Plate 30 of mount 10A has been eliminated as the upper portion of swivel assembly 20 and is replaced by the lower flat surface of the base of an exemplary binding 110 drilled with middle-hole 73 (not shown).

FIG. 10 is an exploded view of an alternative embodiment of mount 10B including exemplary binding 110. Plate 30 of mount 10B has been eliminated as the lower portion of swivel assembly 20 and is replaced by the upper flat surface of snowboard 100, not shown.

Although particular embodiments of the invention have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

1. A mount for attaching a boot binding to a snowboard or for supporting a rider's boot; the snowboard having a top and defining a plane; said mount comprising:
a swivel assembly comprising:
a bearing including:
a lower portion adapted for attachment to the snowboard: said lower portion including:
cant means for supporting said bearing such that the bearing axis is not normal to the plane of the snowboard; and
an upper portion connected to said lower portion and freely swivelable relative thereto about a bearing axis; said upper portion including:
mounting plane means defining a mounting plane for mounting a boot binding or for supporting a rider's boot.

2. A mount for attaching a boot binding to a snowboard or for supporting a rider's boot; the snowboard having a top and defining a plane; said mount comprising:
a swivel assembly comprising:
a bearing including:
a lower portion adapted for attachment to the snowboard; and
an upper portion connected to said lower portion and freely swivelable relative thereto about a bearing axis; said upper portion including:
mounting plane means defining a mounting plane for mounting a boot binding or for supporting a rider's boot.
cant means supporting said mounting plane means such that the mounting plane is not normal to the bearing axis.

3. In combination:
a snowboard generally defining a plane; including:
a top; and
at least two mounting locations, each for mounting a mount;
a mount attached to each said mounting location; each said mount for attaching a boot binding to said snowboard or for supporting a rider's boot; each said mount comprising:
a swivel assembly comprising:
a bearing including:
a lower portion attached to said top of said snowboard; and
an upper portion connected to said lower portion and freely swivelable relative thereto about a bearing axis; said upper portion including:
mounting plane means defining a mounting plane for mounting a boot binding or for supporting a boot.

4. The combination of claim 3 wherein said lower portion includes:
cant means for supporting said bearing such that the bearing axis is not normal to the plane of said snowboard.

5. The combination of claim 3 wherein said upper portion includes:
cant means supporting said mounting plane means such that the mounting plane is not normal to the bearing axis.
